(19) United States
(12) Patent Application Publication
(10) Pub. No.: US 2024/0200689 A1
(43) Pub. Date: Jun. 20, 2024

(54) METHOD FOR DIAGNOSING A PROCESS VALVE ASSEMBLY AND DIAGNOSTIC DEVICE

(71) Applicant: Festo SE & Co. KG, Esslingen (DE)

(72) Inventor: Holger Steltner, Esslingen (DE)

(21) Appl. No.: 18/544,616

(22) Filed: Dec. 19, 2023

(30) Foreign Application Priority Data
Dec. 19, 2022 (DE) 10 2022 133 793.6

(51) Int. Cl. F16K 37/00; G01M 3/28

(52) U.S. Cl. CPC F16K 37/0091; G01M 3/2876

(57) ABSTRACT

A method for the diagnosis, in particular for the leakage recognition, of a process valve assembly unit, said process valve assembly unit including a control device (4), a valve drive (3) which is pneumatically controlled by the control device (4) and a process valve (1) which is driven by the valve drive (4), wherein the method includes the following steps which are carried out by a diagnosis device (50): determining that a diagnosis system state which is suitable for the diagnosis is present after the completion of an actuation of the process valve assembly unit (20), acquiring a temporal course of a measured variable, in particular a pressure, during the diagnosis system state, and on the basis of the acquired temporal course, determining diagnosis information which indicates a diagnosis result, in particular a presence of a leakage, of the process valve assembly unit (20).

### BACKGROUND OF THE INVENTION

The invention relates to a method for the diagnosis, in particular for the leakage recognition, of a process valve assembly unit, said process valve assembly unit comprising a control device, a valve drive which is pneumatically controlled by the control device and a process valve which is driven by the valve drive.

### SUMMARY OF THE INVENTION

An object of the invention lies in providing a reliable method for the diagnosis of the process valve assembly unit.

This object is achieved by a method according to the present invention. The method comprises the following steps which are carried out by a diagnosis device:
determining that, after a completion of an actuation of the process valve assembly unit, a diagnosis system state which is suitable for the diagnosis is present
acquiring a temporal course of a measured variable, in particular a pressure, during the diagnosis system state, and
on the basis of the acquired temporal course, determining diagnosis information which indicates a diagnosis result, in particular a presence of a leakage, of the process valve assembly unit.

Directly after the completion of the actuation of the process valve assembly unit, a temporary change process (in particular not caused by a leakage) of a measured variable, for example of the pressure of the pressurised air in the first pressure chamber, can occur. The completion of the actuation for example is the blocking of a valve, via which the pressurised air (for the purpose of the actuation) is admitted into a first pressure chamber of the valve drive and/or an end of a movement (caused by the actuation) of a piston arrangement of the valve drive. The temporary change process for example is a dropping of the pressure of the pressurised air in the first pressure chamber. This temporary change process is caused for example by way of local temperature effects. After the end of the temporary change process, the measured variable, in particular the pressure, preferably remains constant (for example in the case that no leakage is present). The state of the process valve assembly unit after the end of the temporary change process is also to be denoted as the diagnosis system state.

In order to achieve a reliable diagnosis result, it is advantageous to determine the diagnosis information (in particular exclusively) on the basis of a section of the temporal course of the measured variable, said section being acquired after the end of the temporary change process (thus during the diagnosis system state). In particular, in this manner one can prevent the temporal change process leading to an incorrect diagnosis result. Otherwise, e.g. a temporary change process, in which the pressure drops, can be incorrectly interpreted as a leakage, and accordingly lead to an incorrect diagnosis result.

Due to the fact that in the present invention, one determines that, after the completion of the actuation of the process valve assembly unit, the diagnosis system state which is suitable for the diagnosis is present, and the diagnosis information is then determined on the basis of the temporal course of the measured variable which is acquired during the diagnosis system state, one can prevent the temporary change process which occurs before the diagnosis system state from falsifying the diagnosis information. A higher reliability of the diagnosis can be achieved in this manner.

Advantageous further embodiments are the subject-matter of the dependent claims.

The invention further relates to a diagnosis device.

### BRIEF DESCRIPTION OF THE DRAWINGS

Exemplary embodiments and exemplary details are explained hereinafter with reference to the figures. Herein are shown in:

FIG. 1 a schematic representation of a process valve arrangement, and

FIG. 2 a diagram of a temporal course of a measured variable.

### DETAILED DESCRIPTION

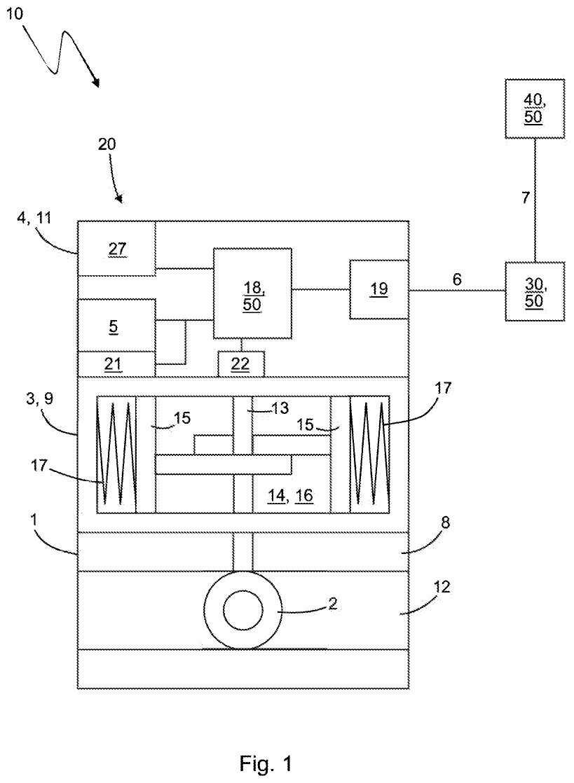

FIG. 1 shows a process valve device 10 which by way of example comprises a process valve assembly unit 120, a superordinate controller 30 and/or a cloud server 40. The process valve assembly unit 20 by way of example is connected to the superordinate controller 30 via a communication line 6, in particular a field bus. The superordinate controller 30 by way of example is a connected to the cloud server 40 via a wide area network 7, for example the internet.

According to a possible embodiment, the process valve assembly unit 20 can be connected to the cloud server via a gateway, in particular an IoT gateway and/or in a direct manner.

The process valve device 10 serves for the application in process automation. Preferably, the process valve device 10 serves for influencing a flow of a process fluid.

The process valve device 10 comprises a process valve 1 with a valve member 2, a pneumatic valve drive 3 for the drive of the process valve 1, in particular of the valve member 2, and a control device 4 with a pneumatic valve device 5 for the pneumatic control of the valve drive 3.

By way of example, the process valve assembly unit 20 is formed by the process valve 1, the valve drive 3 and the control device 4. For example, the process valve 1 has a process valve housing 8, the valve drive 3 a valve drive housing 9 and the control device 4 a control device housing 11. The valve drive housing 9 is fastened to the process valve housing 8 and the control device housing 11 is fastened to the valve drive housing 9. By way of example, the valve drive housing 9 is fastened with its lower side to the upper side of the process valve housing 8 and the control device housing 11 is fastened with its lower side to the upper side of the valve drive housing 9.

The process valve housing 8 by way of example is designed in a tubular manner and defines a process fluid channel 12 which guides the process fluid. The valve member 2 is arranged in the process fluid channel 12, in order to control the flow of the process fluid, in particular to selectively block or release the flow of the process fluid.

The valve drive 3 comprises a drive element 13 which is coupled to the drive member 2 such that the position of the valve member 2 can be changed via a drive movement, in particular a drive rotation movement. of the drive element 13. The valve drive 3 further comprises a piston arrangement 15, via which the drive element 13 can be set into the drive movement.

The valve drive 3 comprises at least one pressure chamber arrangement 14 which is pneumatically controllable by the valve device 5, in order to set the drive element 13 into the drive movement. The pneumatic control is effected by way of feeding and/or discharging pressurised air into/out of the pressure chamber arrangement 14. A pressure is set in the pressure chamber arrangement 14 by way of the pneumatic control. The valve device 5 preferably comprises one or more valves, in particular pneumatic valves, by way of which the control of the valve drive 3 is effected. By way of example, the pressure chamber arrangement 14 comprises a first pressure chamber 16, to which pressurised air can be fed and discharged via the valve device 5.

The valve drive 3 is preferably designed in a single-acting manner, so that the pressure chamber arrangement 14 expediently comprises only one pressure chamber—the first pressure chamber 16. A drive force which (via the piston arrangement 15 and the drive element 13) urges the valve member 2 in the direction of a first position is provided by the pressure which prevails in the first pressure chamber 16. By way of example, the first position is a first end position of the valve member 2, in particular an end position, in which the valve member 2 releases the process fluid channel 12. The valve drive 3 expediently comprises a spring element 17 which provides a restoring force which (via the piston arrangement 15 and the drive element 13) urges the valve member 2 in the direction away from the first position. Expediently, the restoring force urges the drive element 13 into a second end position, in which the valve member 2 blocks the process fluid channel 12.

According to an alternative embodiment which is not shown, the valve drive further comprises a second pressure chamber and expediently not the spring element 17. By way of example, the valve drive is designed in a dual-acting manner.

The control device 4 is preferably designed as a closed-loop position controller or as a positioner. The control device 4 by way of example comprises a control unit 18 which in particular is designed as a microcontroller, and/or a communication unit 19 which in particular serves for the communication with the superordinate controller 30 and/or with the cloud server 40.

The control device 4 comprises the valve device 5 and is designed to admit, by way of the valve device 5, pressurised air into the pressure chamber arrangement 14 and/or to discharge, by way of the valve device 5, pressurised air out of the pressure chamber arrangement 14, in order to set the pressure in the pressure chamber arrangement 14, in particular in the first pressure chamber 16.

The control device 4 expediently further comprises a pressure sensor device 21 and is designed, by way of the pressure sensor device 21. to detect the pressure of the pressure chamber arrangement 14, in particular of the first pressure chamber 16. Expediently, the control device 4 is designed to detect, by way of the pressure sensor device 21, the pressure which prevails in the first pressure chamber 16. Given a dual-acting design of the valve drive, the pressure sensor device 21 is expediently further designed to detect a pressure which prevails in the second pressure chamber of the valve drive 3.

The control device 4 expediently further comprises a position sensor device 22 and is designed to detect, by way of the position sensor device 22, an actual position of the valve member 2, for example by way of a detecting of the position of the drive element 13, from which position the position of the valve member 2 can be derived.

Expediently, the superordinate controller 30 outputs a control command to the control device 4, in particular via the communication line 6. The control command for example specifies a target position for the valve member 2. The control device 4 is preferably designed to carry out a closed-loop control of the position of the valve member 2 on the basis of the control command. For this, the control device 4 compares the actual position which is detected via the position sensor device 22 with the target position which is specified by the control command and on the basis of the comparison sets the drive pressure by way of the valve device 5 such that the actual position changes towards the target position.

By way of example, the process valve device 10 further comprises an operating device 27. The operating device 27 in particular comprises an operating element, for example one or more keys, and optionally a display. The operating device 27 by way of example is part of the process valve assembly unit 20, in particular of the control device 4. Furthermore, the operating device 27 can also be provided as a device which is separate from the process valve assembly unit 20, in particular as a mobile device, for example as a smartphone or tablet, or as a computer.

The process valve device 10 comprises a diagnosis device 50. The diagnosis device 50 can be provided for example on the control unit 18. For example, the diagnosis device 50 is a software which is carried out on the control unit 18. The diagnosis device 50 can furthermore be provided at the superordinate controller 30 and/or at the cloud server 40. Moreover, the diagnosis device 50 can be provided on a mobile device, for example a smartphone. By way of example. the diagnosis device 50 can be distributed onto the control unit 18, the superordinate controller 30, the cloud server 40 and/or the mobile device. The diagnosis device 50 for example can comprise software which runs on the control unit 18, the superordinate controller 30, the cloud server 40 and/or the mobile device.

The diagnosis device 50 serves for carrying out a diagnosis, in particular for leakage recognition, of the pneumatically actuated process valve assembly unit 20.

The diagnosis device 50 is configured to determine that, after a completion of an actuation of the process valve assembly unit 20, a diagnosis system state which is suitable for the diagnosis is present.

The actuation of the process valve assembly unit 20 in particular is effected by way of the control device 4 with its valve device 5 admitting pressurised air into the pressure chamber arrangement 14, in particular into the first pressure chamber 16 or letting air out of therefrom, in order to effect a position change of the drive element 13 (and thus a position change of the valve member 2).

The actuation of the process valve assembly unit 20 should then be considered as in completed when the control device 4 no longer lets pressurised air into the pressure chamber arrangement 14, in particular into the first pressure chamber 16, or no longer lets pressurised air out of it, thus in particular when each valve which is present for this is blocked. Furthermore, the actuation of the process valve assembly unit 20 can be considered as completed when the position change of the drive element and/or of the valve member 2 (which is effected by the inlet and outlet of pressurised air into/out of the pressure chamber arrangement 14) is completed.

Expediently, the diagnosis device 50 is configured to detect the completion of the actuation of the process valve assembly unit 20, for example on the basis of a control of one or more valves of the valve device 5 and/or amid the use of the pressure sensor device 21 and/or of the position sensor device 22 and is optionally designed to provide actuation completion information which indicates that the actuation is completed.

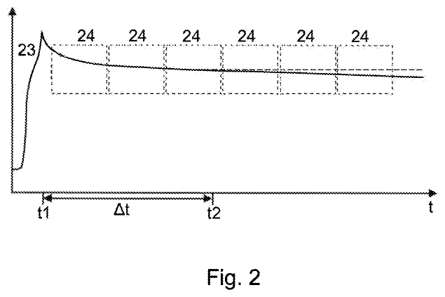

FIG. 2 shows a diagram of a temporal course 23 of a measured variable. The temporal course of the measured variable is also to be denoted as a measured variable course 23. The time t is plotted on the horizontal axis and the value of the measured variable is plotted on the vertical axis. By way of example, the measured variable is the pressure of the pressurised air which is present in the pressure chamber arrangement 14, in particular in the first pressure chamber 16. By way of example, the value of the measured variable increases up to a first point in time t1 and then drops. Preferably. a valve of the valve device 5, via which pressurised air is fed to the pressure chamber arrangement 14, in particular to the first pressure chamber 16, is blocked at the first point in time t1. The pressure drops directly after the first point in time t1 in particular due to the fact that the first pressure chamber 16 expands (on account of a movement of the piston arrangement 15) and/or that local temperature effects occur. In particular, the pressure drops directly after the first point in time t1 due to the fact that the first pressure chamber 16 expands further (on account of the continued movement of the piston arrangement 15). The diagnosis device 50 can detect a blocking of the valve as the completion of the actuation of the process valve assembly unit 20 and expediently provide corresponding actuation completion information. Alternatively, the process valve assembly unit 20 can detect a completion of a position change of the drive element 13 and/or of the valve member 2 as the completion of the actuation and expediently provide corresponding actuation completion information.

The diagnosis system state is for example a system state in which a change process of the measured variable, in particular of the pressure, is completed after the actuation of the process valve assembly unit 20. The change process is triggered by the actuation of the process valve assembly unit 20. The change process of the measured variable which is activated by the actuation by way of example is a drop of the pressure in the first pressure chamber 16, for example caused by local temperature effects. The change process which is activated by the actuation in particular is a temporary change process. As long as the change process is still not yet completed, the probability of a diagnosis, in particular a leakage recognition, providing a falsified result is increased. said diagnosis being carried on the basis of the measured variable course.

Preferably. the diagnosis device 50 is configured to detect that the diagnosis system state is present and expediently to provide, as a response thereto, diagnosis system state information which indicates that the diagnosis system state is present. The determining of the presence of the diagnosis system state in particular is effected (as is explained in more detail hereinafter) on the basis of a waiting time At having expired, and/or on the basis of a signal shape of the measured variable course 23, in particular within one or more time windows 24.

In the example of FIG. 2, the diagnosis system state is given for example from the second point in time t2. The second point in time t2 lies behind the first point in time t1 by a time duration At (which is also to be denoted as the waiting time). FIG. 2 shows a temporal course of the pressure as a dashed line, said course being given in the case in which no leakage is present. By way of example, in this case in which no leakage is present, the pressure in the diagnosis system state (thus by way of example from the second point in time (2) is constant. The temporal course of the pressure which is given in the case in which a leakage is present is shown as an unbroken line. By way of example, in this case in which a leakage is present, the pressure in the diagnosis system state (thus by way of example from the second point in time t2) drops, in particular in a continuous manner.

In both cases—thus with and without leakage—the pressure drops in a similar manner over time in the time interval between the completion of the actuation (thus from the first point in time t1) and the beginning of the diagnosis system state (thus from the second point in time t2), so that a diagnosis which is effected on the basis of a measured variable course which is detected in this time period, in particular leakage recognition, has an increased likelihood of providing an false result.

The diagnosis device 50 is designed to acquire the temporal course 23 of the measured variable, in particular of the pressure, during the diagnosis system state and on the basis of the acquired temporal course to determine diagnosis information which indicates a diagnosis result. in particular a presence of a leakage, of the process valve assembly unit 20. The acquiring of the temporal course of the measured variable during the diagnosis system state and the determining of the diagnosis information on the basis of this temporal course are together also to be denoted as a diagnosis information determining procedure. In particular, the state which is diagnosed by the diagnosis device 50 is to be denoted as the “diagnosis result”. Expediently, the diagnosis device 50 as the diagnosis result selectively determines a first diagnosis result which indicates that no leakage is present, or a second diagnose result which indicates that a leakage is present.

Preferably, the diagnosis serves for leakage recognition. Alternatively to this, the diagnosis can also serve for the recognition of another state, in particular of another error state. The measured variable is preferably a pressure. Expediently, as a response to the pressure changing according to a predefined leakage characteristic during the diagnosis system state, the diagnosis device 50 determines the diagnosis information which indicates a leakage (thus expediently the diagnosis information which indicates the second diagnosis result). The predefined leakage characteristic for example is a predefined slope and/or curve shape of the temporal course 23 of the measured variable during the diagnosis system state.

Different variants as to how one can determine that the diagnosis system state is present are dealt with in more detail hereinafter.

Preferably, the diagnosis device 50 determines a time information and on the basis of the time information determines that the diagnosis system state is present. For example, the time information defines the waiting time At. The time information preferably comprises a waiting time value which defines the waiting time At. As a response to the waiting time having expired, the diagnosis device 50 determines that the diagnosis system state is present. For example, the diagnosis device 50 examines as to whether, starting from the completion of the actuation of the process valve assembly unit 20, thus by way of example starting from the first point in time t1, the waiting time At has expired, and as a response to the waiting time At having expired ascertains that the diagnosis system state is present.

Preferably, the diagnosis device 50 determines the time information on the basis of valve drive property information. in particular of a drive size and/or on of a housing material and/or of valve drive identification information. The valve drive identification information for example is an identifier of the valve drive 3. Preferably, the diagnosis device 50 computes the time information on the basis of the valve drive property information whilst using a mathematical model and/or retrieves the time information on the basis of the valve drive identification information from a database.

Preferably, the diagnosis device 50 uses the mathematical model in order to estimate system properties which are of relevance to the waiting time from the valve drive property information (thus in particular known properties of the connected valve drive 3, e.g. drive size, housing material) and to compute the waiting time on the basis of this. For estimating the system properties and/or for the computation of the waiting time, the diagnosis device 50 preferably carries out model-assisted computations, in particular in the control device 4, in a superordinate instance (e.g. the super-ordinate controller 30) and/or on a remote server (e.g. in the cloud server 40).

The diagnosis device 50 preferably retrieves the valve drive property information and/or the mathematical model according to the identification information of the valve drive 3 from a database. By way of example, the diagnosis device 50 derives the properties which are necessary for the computation from the identification information (e.g. from an unambiguous identification of the valve drive 3), e.g. by way of an automated enquiry of corresponding property data, or downloads a complete simulation model from a database of the manufacturer of the valve drive 3.

A variant in which the time information is computed by way of interpolation is explained hereinafter.

Preferably, a database is firstly created, in which database the property information of various valve drives in assignment to a respective time information, in particular a respective waiting time, are included. The property information for example includes the drive size and/or the housing material of the respective valve drive. Preferably, computations for determining the time information (to be included in the database), in particular the waiting time, are carried out in advance for a series of known valve drives of a different type and a different size, in particular for valve drives, for which a corresponding model with matching model parameter values is known.

Preferably, the diagnosis device 50 compares the valve drive property information of the valve drive 3 with the property information of other valve drives which is stored in the database, in order to identify a valve drive which is similar to the valve drive 3. Preferably, the diagnosis device 50 compares properties which are known via the connected valve drive 3 with corresponding properties of other valve drives, in order to determine the most similar drive (or the most similar drives).

The diagnosis device 50 carries out an interpolation on the basis of time information which is assigned to the similar valve drive, in order to compute the time information. Optionally, the diagnosis device 50 generates a warning hint if no or not enough similar drives could be found in the database in order to permit an adequately reliable estimation of the time information.

Preferably, the comparison of the valve drive property information of the valve drive 3 with the property information of other valve drives which is stored in the database and/or the execution of the interpolation are carried out in the control device 4 or in a superordinate entity, for example the superordinate controller and/or the cloud server 40.

Optionally, for determining the time information the diagnosis device 50 takes into account a dependence of the time information on certain application conditions (e.g. temperature or supply pressure). By way of example, this dependency is contained in the mathematic model which the diagnosis device 50 uses for the computation of the time information.

Preferably, the diagnosis device 50 amid the use of the time information which is computed by the interpolation determines that the diagnosis system state is present (for example as a response to the diagnosis device 50 ascertaining that the waiting time At which is defined by the time information has expired since the completion of an actuation of the process valve assembly unit 20). The diagnosis device 50 acquires the temporal course of the measured variable, in particular of the pressure, during the diagnosis system state and on the basis of the acquired temporal course determines the diagnosis information which indicates the diagnosis result, in particular a presence of leakage, of the process valve assembly unit 20.

A further variant as to how the waiting time At can be determined is explained hereinafter.

Preferably, the diagnosis device 50 repeatedly carries out a determining of the diagnosis information amid the use of a pre-set waiting time. The pre-set waiting time for example is stored beforehand in the diagnosis device 50, for example as a default value. The thus determined pieces of diagnosis information are also to be denoted as diagnosis information candidates. Expediently, using the pre-set waiting time in each case, the diagnosis device 50 carries out an determination that the diagnosis system state is present for a plurality of (in particular successively executed) actuations of the process valve assembly unit 20, namely in each case as a response to the 30 diagnosis device 50 determining that the pre-set waiting time has elapsed since the completion of the respective actuation of the process valve assembly unit 20. The diagnosis device 50 (after each of the actuations) acquires the respective temporal course of the measured variable, in particular the pressure, during the respective diagnosis system state and on the basis of the respectively acquired temporal course determines a respective diagnosis information which indicates a respective diagnosis result. This determined respective diagnosis information is also to be denoted as a diagnosis information candidate. The determining of the diagnosis information candidates is also to be denoted as the candidate determining procedure.

The diagnosis device 50 compares the diagnosis information (which can also be denoted as diagnosis information candidates) with one another. In particular, the diagnosis device 50 examines whether the diagnosis information candidates are consistent with one another - thus in particular whether the diagnosis information candidates (in particular within the scope of estimation uncertainties) agree, thus for example whether each indicates the same diagnosis result. On the basis of a scatter of the diagnosis information candidates, the diagnosis device 50 preferably examines whether the diagnosis information candidates are consistent (preferably whilst taking into account further constraints, e.g. a respective movement direction of the piston arrangement 15 with the respective preceding actuation). The comparison of the diagnosis information candidates is also to be denoted as the candidate comparison procedure.

Preferably, the diagnosis device 50 adapts the waiting time on the basis of the determined diagnosis information (thus in particular of the diagnosis information candidates). In particular, the diagnosis device 50 adapts the waiting time as a response to the diagnosis information candidates not being consistent (e.g. if the diagnosis information candidates indicate different diagnosis results). The diagnosis device 50 preferably increases the waiting time in response to the diagnosis information candidates not being consistent. The adaptation of the waiting time is also to be denoted as the waiting time adaptation procedure.

The diagnosis device 50 carries out the candidate determining procedure afresh and specifically amid the use of the adapted waiting time (instead of the pre-set waiting time). The diagnosis device 50 repeatedly carries out a determining of the diagnosis information on the basis of the adapted waiting time and adapts the waiting time further on the basis of the thus determined diagnosis information.

Preferably, the diagnosis device 50 carries out the candidate determining procedure (with the respective previously adapted waiting time), the candidate comparison procedure and the waiting time adaption procedure in a successive manner (in particular as a loop) until the diagnosis information candidates agree. As long as the diagnosis information candidates do not yet agree, the diagnosis device 50 increases the waiting time with each execution of the waiting time adaptation procedure. Expediently, as a response to the diagnosis information candidates which are determined in the candidate determining procedure being consistent (thus for example agreeing), the diagnosis device 50 sets the currently valid waiting time (on the basis of which the consistent diagnosis information candidates were obtained) as the waiting time which is to be used in the future (or shortens the waiting time). The diagnosis device 50 preferably uses this set waiting time when in the future it is determined that the diagnosis system state is present.

Preferably, the diagnosis information candidates which are determined in the respective candidate determining procedure are stored in an intermediate memory and are not outputted as diagnosis information, in particular are not transferred externally. Preferably, as a response to the diagnosis device 50 determining that the diagnosis information candidates are constant with regard to the candidate comparison procedure, the diagnosis device 50 issues at least one of the diagnosis information candidates as diagnosis information.

A further variant as to how the diagnosis device 50 can determine that the diagnosis system state is present is explained hereinafter.

The diagnosis device 50 preferably determines that the diagnosis system state is present on the basis of the temporal course. For example, the diagnosis device 50 adapts a fitting function to the temporal course and on the basis of a deviation between the fitting function and the temporal course and/or on the basis of at least one fitting parameter of the fitting function determines that the diagnosis system state is present.

For example, the diagnosis device 50 in a time window 24 determines the temporal course of the measured variable, in order to obtain a section of the temporal course. The diagnosis device 50 adapts a fitting function to the section of the temporal course, in order to obtain a fitting parameter. For example, the diagnosis device 50 as the fitting function adapts a straight line to the section, in order to obtain a slope of the adapted straight line as the fitting parameter.

By way of example, the diagnosis device 50 comprise a mathematical model which describes the temporal course of the measured variable in the diagnosis system state, in particular for the case that leakage is present. The diagnosis device 50 expediently uses this mathematical model as the fitting function.

For example, the diagnosis device 50 uses the following mathematical model as a fitting function:

$$p ( t ) = {p}_{offset} + Δ p \cdot {e}^{- μ ( t - {t}_{0} )}$$

This mathematical model describes the temporal pressure course p(t) in the first pressure chamber 16. The model parameter p_{offset}, Δp and/or μ expediently serve as fitting parameters via which the mathematical model is adapted to the temporal course of the measured variable. The parameter to is the starting point in time of the section of the temporal course, to which the mathematical model is to be adapted.

Alternatively or additionally to this, the diagnosis device 50 expediently uses the following mathematic model as an fitting function:

$$p ( t ) = {p}_{offset} + {m}_{p} \cdot ( t - {t}_{0} )$$

The model parameters p_{offset} and/or mₚ expediently serve as fitting parameters, via which the mathematical model is adapted to the temporal course of the measured variable.

Optionally, the diagnosis device 50 checks whether a basic precondition for the reaching of the diagnosis system state is fulfilled. The basic precondition for example is that no position change of the drive element 13 has taken place over a predefined time period. In particular, as a response to the basic precondition being present, the diagnosis device 50 carries out an adaption of the fitting function to a measured signal course of the temporal course of the measured variable. The adaptation of the fitting function is effected for example by way of an adapting of one or more fitting parameters of the fitting function. For example, the diagnosis device 50 estimates one or more fitting parameters for the adaptation of the fitting function.

The diagnosis device 50 examines as to whether an adequately good agreement for a minimum time period with consistent fitting parameters is given between the measured signal course of the temporal course of the measured variable and the adapted fitting function (which can also be denoted as a “modelled signal course”). For example, the diagnosis device examines whether for a predefined minimum time period a deviation of the adapted fitting function from the measured temporal course of the measured variable lies below a predefined threshold value. As a response to this being the case, the diagnosis device 50 determines that the diagnosis system state is present and expediently carries out the diagnosis information determining procedure. As a response to this not being the case, the diagnosis device 50 determines that the diagnosis system state is not present and expediently does not carry out the diagnosis information determining procedure, but preferably continues to examine whether the deviation lies below the predefined threshold value.

Preferably, the diagnosis device 50 adapts the fitting function several times in succession to temporally consecutive sections of the temporal course, in order to obtain at least one respective fitting parameter for each section. Preferably, as a response to the fitting parameters of the different sections corresponding to another, the diagnosis device 50 determines that the diagnosis system state is present.

The temporally consecutive sections of the temporal course for example lie in respective temporally consecutive time windows 24, as is shown e.g. in FIG. 2. By way of example, each section or each time window 24 is several seconds long, for example 1 to 2 seconds. Preferably the diagnosis device 50 assesses for each section as to whether the respectively adapted fitting function fulfils a fitting criterion, for example whether a deviation of the respectively adapted fitting function from the respective section is smaller than a predefined threshold value. Optionally, the diagnosis device 50 examines whether the respective fitting function fulfils the fitting criterion for a predefined number of, for example 3 consecutive sections. As a response to this being the case, the diagnosis device 50 compares one or more fitting parameters, in particular a respective slope, of the fitting functions which fulfil the fitting criterion, with one another. As long as the fitting parameters correspond to one another, in particular are equal or have a difference to one another below a predefined threshold value, the diagnosis device 50 determines that the diagnosis system state is present. The diagnosis device 50 preferably determines the diagnosis information on the basis of at least one fitting parameter. Optionally, the diagnosis device 50 uses one or more fitting parameters, in order to determine the diagnosis information on the basis of these. For example, the diagnosis device compares a fitting parameter which represents a slope of the temporal course of the measured variable with a threshold value and on the basis of the comparison determines whether a leakage is present or not and provides corresponding diagnosis information which indicates whether the leakage is present or not.

What is claimed is:

1. A method for a diagnosis of a process valve assembly unit, the process valve assembly unit comprising a control device, a valve drive which is pneumatically controlled by the control device and a process valve which is driven by the valve drive, wherein the method comprises the following steps which are carried out by a diagnosis device:
determining that, after a completion of an actuation of the process valve assembly unit, a diagnosis system state which is suitable for the diagnosis is present;
acquiring a temporal course of a measured variable during the diagnosis system state; and
on the basis of the acquired temporal course, determining diagnosis information which indicates a diagnosis result of the process valve assembly unit.

2. The method according to claim 1, wherein the diagnosis system state is a system state in which a change process of the measured variable is completed after the actuation of the process valve assembly unit, said change process being triggered by the actuation.

3. The method according to claim 1, wherein the diagnosis serves for leakage recognition and the measured variable is a pressure, and wherein the diagnosis device determines, as a response to the pressure changing according to a predefined leakage characteristic during the diagnosis system state, the diagnoses information which as the diagnosis result indicates the presence of leakage.

4. The method according to claim 1, wherein the diagnosis device determines time information and on the basis of the time information determines that the diagnosis system state is present.

5. The method according to claim 4, wherein the time information defines a waiting time and as a response to the waiting time having expired, the diagnosis device determines that the diagnosis system state is present.

6. The method according to claim 5, wherein the diagnosis device repeatedly carries out a determining of the diagnosis information amid the use of a pre-set waiting time and adapts the pre-set waiting time on the basis of the thus determined pieces of diagnosis information, in order to obtain the waiting time.

7. The method according to claim 4, wherein the diagnosis device determines the time information on the basis of valve drive property information and/or of valve drive identification information.

8. The method according to claim 7, wherein the diagnosis device computes the time information on the basis of the valve drive property information amid the use of a mathematical model and/or retrieves the time information from a database on the basis of the valve drive identification information.

9. The method according to claim 8, wherein the diagnosis device retrieves the valve drive property information and/or the mathematical model according to the identification information of the valve drive from a database.

10. The method according to claim 7, wherein the diagnosis device compares the valve drive property information of the valve drive with property information of other valve drives which is stored in a database, in order to identify a valve drive which is similar to the valve drive, and wherein the diagnosis device carries out an interpolation on the basis of time information which is assigned to the similar valve drive, in order to compute the time information, on the basis of which the diagnosis device determines that the diagnosis system state is present.

11. The method according to claim 7, wherein the valve property information comprises a drive size and/or a housing material.

12. The method according to claim 1, wherein the diagnosis device determines that the diagnosis system state is present on the basis of the temporal course of the measured variable.

13. The method according to claim 12, wherein the diagnosis device adapts a fitting function to the temporal course and on the basis of a deviation between the fitting function and the temporal course and/or on the basis of at least one fitting parameter of the fitting function determines that the diagnosis system state is present.

14. The method according to claim 13, wherein the diagnosis device adapts the fitting function several times in succession to temporally consecutive sections of the temporal course, in order to obtain at least one respective fitting parameter for each section, and as a response to the fitting parameters of the different sections corresponding to another, determines that the diagnosis system state is present.

15. The method according to claim 13, wherein the diagnosis device determines the diagnosis information on the basis of the at least one fitting parameter.

16. The method according to claim 1, wherein the diagnosis serves for leakage recognition, the measured variable is a pressure, and the diagnosis result indicates a presence of leakage.

17. A diagnosis device for carrying out a diagnosis of a process valve assembly unit which comprises a control device, a valve drive which can be controlled by the control device and a process valve which can be driven by the valve drive, wherein the diagnosis device is configured to determine that, after a completion of an actuation of the process valve assembly unit, a diagnosis system state which is suitable for the diagnosis is present, to acquire a temporal course of a measured variable during the diagnosis system state, and on the basis of the detected temporal course to determine diagnosis information which indicates a diagnosis result of the process valve assembly unit.
